(19) United States
(12) Patent Application Publication
(10) Pub. No.: US 2015/0074100 A1
(43) Pub. Date: Mar. 12, 2015

(54) METHOD AND APPARATUS FOR OBTAINING ADDRESS BOOK, AND SERVER

(71) Applicant: Huawei Technologies Co., Ltd., Shenzhen (CN)

(72) Inventors: Hongmin Xu, Hangzhou (CN); Wanling Chen, Shenzhen (CN)

(21) Appl. No.: 14/548,132

(22) Filed: Nov. 19, 2014

Related U.S. Application Data
(63) Continuation of application No. PCT/CN2013/083295, filed on Sep. 11, 2013.

(30) Foreign Application Priority Data
Sep. 11, 2012 (CN) 201210333582.6

(51) Int. Cl. G06F 17/30

(52) U.S. Cl. CPC G06F 17/30554; G06F 17/3053
USPC 707/731

(57) ABSTRACT

The present invention provides a method and an apparatus for obtaining an address book, and a server. The method includes: performing matching in the address book according to a name to be searched for and entered by a user, to obtain to-be-sorted names; and obtaining a sorting attribute of the to-be-sorted names, sorting the to-be-sorted names according to the sorting attribute, and generating a name list, where the sorting attribute includes a department attribute or a department contact frequency. According to the method and apparatus for obtaining an address book, and the server in embodiments of the present invention, names that match a name to be searched for are sorted according to a sorting attribute, so that a user can find a desired name quickly and obtain corresponding contact information or other information, which saves the user's search time and improves user experience.

### CROSS-REFERENCE TO RELATED APPLICATIONS

This application is a continuation of International Application No. PCT/CN2013/083295, filed on Sep. 11, 2013, which claims priority to Chinese Patent Application No. 201210333582.6, filed on Sep. 11, 2012, both of which are hereby incorporated by reference in their entireties.

### TECHNICAL FIELD

The present invention relates to communications technologies, and in particular, to a method and an apparatus for obtaining an address book, and a server.

### BACKGROUND

In large enterprises, an address book that includes contact information of all employees is generally provided to facilitate liaison between employees in the enterprises. However, because the number of employees is huge, many duplicate names exist, and multiple employees of a same name may be searched out at the time of searching for contact information of an employee in the same enterprise. Especially, in some international-oriented enterprises, a full name in English or a short name in English or another manner is customarily used to search for contact information of an employee, which may lead to more duplicate names. In this case, searching for the names one by one is a huge waste of time.

### SUMMARY

The present invention provides a method and an apparatus for obtaining an address book, and a server, so as to rectify a defect in the prior art that time is wasted in searching for contact information of an employee.

A first aspect of the present invention provides a method for obtaining an address book, including:

performing matching in the address book according to a name to be searched for and entered by a user, to obtain to-be-sorted names; and

obtaining a sorting attribute of the to-be-sorted names, sorting the to-be-sorted names according to the sorting attribute, and generating a name list, where the sorting attribute includes a department attribute or a department contact frequency.

In the method for obtaining an address book described above, preferably, the obtaining a sorting attribute of the to-be-sorted names, sorting the to-be-sorted names according to the sorting attribute, and generating a name list, include:

obtaining the department attribute of the to-be-sorted names;

obtaining names with a department attribute that is the same as a department attribute of the user from the to-be-sorted names, and names with a department attribute that is different from the department attribute of the user from the to-be-sorted names; and

generating the name list according to the names with the same department attribute and the names with a different department attribute.

In the method for obtaining an address book described above, preferably,

the generating the name list according to the names with the same department attribute and the names with a different department attribute includes:

obtaining first department contact frequencies between the user and the names with a different department attribute;

sorting the names with a different department attribute in descending order of the first department contact frequencies; and

generating the name list according to the names with the same department attribute and the sorted names with a different department attribute, where the names with the same department attribute are arranged above the names with a different department attribute.

In the method for obtaining an address book described above, preferably, the first department contact frequency is a sum of contact frequencies between the user and all users in a department to which the names with a different department attribute belong.

In the method for obtaining an address book described above, preferably, after the sorting the names with a different department attribute in descending order of the first department contact frequencies and before the generating the name list according to the names with the same department attribute and the sorted names with a different department attribute, the method further includes:

when the names with a different department attribute include multiple to-be-adjusted names with a same department attribute, obtaining second department contact frequencies between all to-be-adjusted names and the user; and

sorting the to-be-adjusted names with the same department attribute in descending order of the second department contact frequencies.

In the method for obtaining an address book described above, preferably, the second department contact frequency is a sum of contact frequencies between each to-be-adjusted name and all users in a department to which the user belongs.

In the method for obtaining an address book described above, preferably,

before the generating the name list according to the names with the same department attribute and the sorted names with a different department attribute, the method further includes:

obtaining third contact frequencies between the names with the same department attribute and the user;

sorting the names with the same department attribute in descending order of the third department contact frequencies, where

the third contact frequency is a sum of contact frequencies between the names with the same department attribute and all users in the department to which the user belongs.

In the method for obtaining an address book described above, preferably, after the obtaining to-be-sorted names, and before the obtaining a sorting attribute of the to-be-sorted names, the method further includes:

determining the number of the to-be-sorted names; and

when the number of the to-be-sorted names is greater than 1, performing an operation of obtaining the sorting attribute of the to-be-sorted names.

Another aspect of the present invention provides an apparatus for obtaining an address book, including:

a matching module, configured to perform matching in the address book according to a name to be searched for and entered by a user, to obtain to-be-sorted names; and

a generating module, configured to obtain a sorting attribute of the to-be-sorted names, sort the to-be-sorted names according to the sorting attribute, and generate a name list, where the sorting attribute includes a department attribute or a department contact frequency.

In the apparatus for obtaining an address book described above, preferably, the generating module includes:

a first obtaining submodule, configured to obtain the department attribute of the to-be-sorted names;

a second obtaining submodule, configured to obtain names with a department attribute that is the same as a department attribute of the user from the to-be-sorted names, and names with a department attribute that is different from the department attribute of the user from the to-be-sorted names; and

a sorting submodule, configured to generate the name list according to the names with the same department attribute and the names with a different department attribute.

In the apparatus for obtaining an address book described above, preferably, the sorting submodule is specifically configured to:

obtain first department contact frequencies between the user and the names with a different department attribute;

sort the names with a different department attribute in descending order of the first department contact frequencies; and

generate the name list according to the names with the same department attribute and the sorted names with a different department attribute, where the names with the same department attribute are arranged above the names with a different department attribute.

In the apparatus for obtaining an address book described above, preferably, the sorting submodule is further specifically configured to:

when the names with a different department attribute include multiple to-be-adjusted names with a same department attribute, obtain second department contact frequencies between all to-be-adjusted names and the user; and

sort the to-be-adjusted names with the same department attribute in descending order of the second department contact frequencies.

In the apparatus for obtaining an address book described above, preferably, the sorting submodule is further configured to:

obtain third contact frequencies between the names with the same department attribute and the user; and

sort the names with the same department attribute in descending order of the third department contact frequencies, where

the third contact frequency is a sum of contact frequencies between the names with the same department attribute and all users in a department to which the user belongs.

The apparatus for obtaining an address book described above preferably further includes:

a determining module, configured to determine the number of the to-be-sorted names; and, when the number of the to-be-sorted names is greater than 1, perform an operation of obtaining the sorting attribute of the to-be-sorted names.

The apparatus for obtaining an address book described above preferably further includes:

a priority identifying module, configured to identify priorities of the to-be-sorted names, where a priority of a to-be-sorted name that exactly matches the name to be searched for is higher than a priority of a to-be-sorted name that does not exactly match the name to be searched for; and sort the to-be-sorted names in descending order of the priorities.

Still another aspect of the present invention provides a server, including:

a memory, configured to store an instruction; and

a processor, coupled to the memory, and configured to execute the instruction stored in the memory and execute any method for obtaining an address book described above.

It can be learnt from the foregoing technical solutions that, according to a method and an apparatus for obtaining an address book, and a server provided by the present invention, names that match a name to be searched for are sorted according to a sorting attribute, so that a user can find a desired name quickly and obtain corresponding contact information or other information, which saves the user's search time and improves user experience.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show some embodiments of the present invention, and persons of ordinary skill in the art may still derive other drawings from these accompanying drawings without creative efforts.

FIG. 1 is a schematic flowchart of a method for obtaining an address book according to an embodiment of the present invention;

FIG. 2 is a schematic flowchart of a method for obtaining an address book according to another embodiment of the present invention;

FIG. 3 is a schematic structural diagram of an apparatus for obtaining an address book according to another embodiment of the present invention; and

FIG. 4 is a schematic structural diagram of an apparatus for obtaining an address book according to another embodiment of the present invention.

### DETAILED DESCRIPTION

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are a part rather than all of the embodiments of the present invention. All other embodiments obtained by persons of ordinary skill in the art based on the embodiments of the present invention without creative efforts shall fall within the protection scope of the present invention.

### Embodiment 1

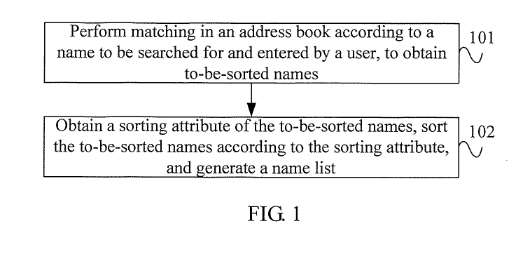

This embodiment provides a method for obtaining an address book. FIG. 1 is a schematic flowchart of the method for obtaining an address book. The method is executed by an apparatus for obtaining an address book, and the apparatus may be integrated into a server.

Step 101: Perform matching in the address book according to a name to be searched for and entered by a user, to obtain to-be-sorted names.

First, the user enters the name to be searched for on a user terminal, the user terminal sends the name to be searched for to the apparatus for obtaining an address book, and the apparatus for obtaining an address book matches the name to be searched for in a pre-stored address book. The address book may include contact information of all users in an enterprise, such as a contact name, a fixed-line phone number, a mobile phone number, and a home address, which may be specifically set according to an actual requirement.

In a practical operation, when the user enters a name to be searched for “Zhang San” or “zhangsan”, the apparatus for obtaining an address book displays a name list to the user according to the name to be searched for. The name list may include a name “Zhang San” that exactly matches the name to be searched for, and may also include some names that include “Zhang San”, such as “Zhang Sanfeng” and “Li Zhangsan”.

Preferably, a to-be-sorted name in this embodiment is a name that exactly matches the name to be searched for, so as to reduce the number of the to-be-sorted names and relieve a burden of the apparatus for obtaining an address book.

Step 102: Obtain a sorting attribute of the to-be-sorted names, sort the to-be-sorted names according to the sorting attribute, and generate a name list.

The sorting attribute comes in many types such as one or more of: a department attribute, a job attribute, and department contact frequency. A specific way of sorting the to-be-sorted names according to the sorting attribute may be set according to an actual requirement. For example, the sorting is based on a department size, a job title, or the department contact frequency. After the sorting, the to-be-sorted names form the name list.

“Department” in the present invention may be divided into multi-level departments. Department levels may be set by the enterprise according to specific conditions. Two major aspects are considered in defining the department levels: first, a department size cannot be too large or too small, so as to avoid too many duplicate names in a too large department and avoid that no employee is matched in a too small department; second, business similarity is high or work contact is frequent in a department because business contact or work contact is a major factor for generating communication requirements between enterprise employees, and, if business correlation in the department is low, an assumption that contact frequency is the highest in a same department is denied. Therefore, the “department” in this embodiment is preferably a department of the last but one level, which ensures that the department size is not too small and there is frequent contact of business.

Optionally, after step 102, the name list may be further returned to the user, so that the user obtains an obtaining manner according to the name list.

After generating the name list, the apparatus for obtaining an address book returns the name list to the user. The user can see the name list by using a display of the user terminal, and can search out contact information of a desired contact person by using the name list.

Preferably, after step 101 and before step 102, the method further includes:

determining the number of the to-be-sorted names; and, when the number of the to-be-sorted names is greater than 1, performing an operation of obtaining the sorting attribute of the to-be-sorted names; that is, when the number of the to-be-sorted names is 1, returning the to-be-sorted name to the user; otherwise, performing step 102. For example, when only one to-be-sorted name “Zhang San” is obtained according to a name to be searched for “Zhang San”, the apparatus for obtaining an address book directly returns the “Zhang San” to the user. The user may click the name of the “Zhang San” to obtain relevant contact information, or the name of “Zhang San” returned by the apparatus for obtaining an address book to the user includes all contact information of the “Zhang San”. According to a method for obtaining an address book in this embodiment, names that match a name to be searched for are sorted according to a sorting attribute, so that a user can find a desired name quickly and obtain corresponding contact information or other information, which saves the user's search time and improves user experience. “Multiple” in the present invention may be understood as being greater than 1, such as 2, 4, 10, or even more.

### Embodiment 2

This embodiment provides a method for obtaining an address book based on Embodiment 1.

Step 200: Receive a query request of a user, where the query request includes a name to be searched for.

First, the user uses a user terminal to send the query request to an apparatus for obtaining an address book, where the query request includes at least the name to be searched for.

Step 201: Perform matching in the address book according to the name to be searched for and entered by the user, to obtain to-be-sorted names.

For example, if the name to be searched for included in the query request that is sent by the user is “zhangyi”, one or more names that match the name to be searched for may appear. This embodiment is described by using an example in which the to-be-sorted names exactly match the name to be searched for, for example, “Zhang Yi (1)”, “Zhang Yi (2)”, “Zhang Yi (3)”, and “Zhang Yi (4)”. When one to-be-sorted name appears, the apparatus for obtaining an address book directly returns the to-be-sorted name to the user; when multiple to-be-sorted names appear, the apparatus for obtaining an address book performs a subsequent operation of generating a name list.

Step 202: Obtain a sorting attribute of the to-be-sorted names.

The apparatus for obtaining an address book obtains the sorting attribute of the to-be-sorted names from a pre-stored database. The database may store all kinds of information corresponding to each name, for example, a department, a job, a birthday, a mobile phone number, a fixed-line phone number, and a home address. One or more of them may be selected as the sorting attribute. In this embodiment, a department attribute or a department contact frequency or both are used as the to-be-sorted attribute, where a priority of the department attribute is higher than a priority of the department contact frequency. The department contact frequency may include one or more of a first department contact frequency, a second department contact frequency, and a third department contact frequency. The first department contact frequency is a sum of contact frequencies between the user and all users in a department to which the names with a different department attribute belong. The second department contact frequency is a sum of contact frequencies between the names with a different department attribute and all users in a department to which the user belongs. The third department contact frequency is a sum of contact frequencies between the names with the same department attribute and all users in a department to which the user belongs. A priority of the first department contact frequency is higher than a priority of the second department contact frequency. Table 1 shows an address book that includes “zhangyi”.

TABLE 1

| | | First de- | Second de- | Third de- | |
|---|---|---|---|---|---|
| | | partment | partment | partment | |
| | | contact | contact | contact | Phone |
| | Department | frequency | frequency | frequency | number |
| Zhang Yi | Marketing | 2 | 4 | | XXX |
| (1) | department | | | | |
| . . . | . . . | . . . | . . . | | . . . |
| Zhang Yi | Planning | 1 | 3 | 4 | XXX |
| (2) | department | | | | |
| Zhang Yi | Planning | 3 | 2 | 5 | XXX |
| (3) | department | | | | |
| . . . | . . . | . . . | . . . | | . . . |
| Zhang Yi | Sales | 4 | 5 | | XXX |
| (4) | department | | | | |
| Zhang Yi | Sales | 4 | 7 | | XXX |
| (5) | department | | | | |

The contact frequency may be obtained according to a uniform liaison tool in the enterprise, such as a uniform communication tool in the enterprise, a personal handy-phone system, or an email. The contact frequency between users may be measured by using such liaison tools. For example, if the user chats to Zhang Yi (3) once, the first department contact frequency is 1; if an email is exchanged between the user and Zhang Yi (3) additionally, the first department contact frequency increases by 1 and becomes 2; if an SMS message is exchanged between the user and Zhang Yi (2), the first department contact frequency increases by 1 and becomes 3; and, if the user subsequently contacts anyone in the planning department by using an IM (Instant Messenger, instant messenger), the contact frequency increases by 1 again and becomes 4. When the user or Zhang Yi (3) changes a department, the original contact frequency may be emptied. In addition, it should be pointed out that, it is appropriate to obtain only the contact frequency of one or more of the liaison tools. For example, employees in an enterprise mostly contact each other by using emails, so that it is appropriate to obtain only the contact frequency of emails.

Step 203: Obtain names with a department attribute that is the same as a department attribute of the user from the to-be-sorted names, and names with a department attribute that is different from the department attribute of the user from the to-be-sorted names.

The apparatus for obtaining an address book compares the department attribute of the user with a department attribute corresponding to the to-be-sorted names. The apparatus for obtaining an address book obtains the department attribute of the user in many ways. For example, the department attribute of the user is obtained by using a MAC address or an IP address of a terminal used by the user, or according to a communication tool login account or a computer domain account. The department attribute of the user may also be included in the query request sent by the user, which may be specifically set according to an actual requirement and is not repeated here. It should be pointed out that when the address book is obtained, related information corresponding to the name is also obtained. The user searches for desired information according to the name, and therefore, in this embodiment, sorting of names is specifically described by using examples, so as to ensure that the user obtains the desired information as soon as possible.

When the user's department is the planning department, according to Table 1, the obtained names with the same department attribute are “Zhang Yi (2)” and “Zhang Yi (3)”, and the obtained names with a different department attribute are “Zhang Yi (1)” and “Zhang Yi (4)”.

Step 204: Generate the name list according to the names with the same department attribute and the names with a different department attribute, where the names with the same department attribute are arranged above the names with a different department attribute.

Assuming that the department attribute of the user is the planning department, the apparatus for obtaining an address book arranges the names of two persons “Zhang Yi (2)” and “Zhang Yi (3)” of the same department attribute above other two names.

Step 204 may specifically include:

Step 204a: Obtain first department contact frequencies between the user and the names with a different department attribute.

Step 204b: Sort the names with a different department attribute in descending order of the first department contact frequencies.

Step 204c: Generate the name list according to the names with the same department attribute and the sorted names with a different department attribute, where the names with the same department attribute are arranged above the names with a different department attribute.

When the number of the names with a different department attribute is greater than 1, steps 204a-204c may be performed. In this embodiment, the names with a different department attribute are “Zhang Yi (1)”, “Zhang Yi (4)”, and “Zhang Yi (5)”, and therefore, “Zhang Yi (1)” should be arranged below “Zhang Yi (4)” and “Zhang Yi (5)” according to the contact frequency. In this case, an order between the two is adjusted and a final name list 1 is generated.

Name list 1

Zhang Yi (2)
Zhang Yi (3)
Zhang Yi (4)
Zhang Yi (5)
Zhang Yi (1)

Certainly, after step 204b and before step 204c, the method may further include:

when the names with a different department attribute include multiple to-be-adjusted names with a same department attribute, obtaining second department contact frequencies between all to-be-adjusted names and the user; and sorting the to-be-adjusted names with the same department attribute in descending order of the second department contact frequencies.

For example, according to Table 1, the number of the to-be-adjusted names with the same department attribute among the names with a different department attribute is 2, and the to-be-adjusted names are “Zhang Yi (4)” and “Zhang Yi (3)”, and therefore, “Zhang Yi (5)” in the to-be-adjusted names should be arranged above “Zhang Yi (4)”, as shown in the name list 2.

Name list 2

Zhang Yi (2)
Zhang Yi (3)
Zhang Yi (5)
Zhang Yi (4)
Zhang Yi (1)

Optionally, before step 204, the method may further include:

obtaining third department contact frequencies between the names with the same department attribute and the user; and

sorting the names with the same department attribute in descending order of the third department contact frequencies, where

the third department contact frequency is a sum of contact frequencies between the names with the same department attribute and all users in the department to which the user belongs.

That is, when there are multiple names with the same department attribute, sorting may also be performed according to the third department contact frequency. In this embodiment, there are 2 names with the same department attribute, which are “Zhang Yi (2)” and “Zhang Yi (3)”. According to statistics, the third department contact frequency corresponding to “Zhang Yi (2)” is 4, and the third department contact frequency corresponding to “Zhang Yi (3)” is 5, and therefore, “Zhang Yi (3)” should be arranged above “Zhang Yi (2)”, as shown in the name list 3.

Name list 3

Zhang Yi (3)
Zhang Yi (2)
Zhang Yi (5)
Zhang Yi (4)
Zhang Yi (1)

In addition, it should be pointed out that, it is appropriate to sort the names with the same department attribute only according to the third department contact frequency, or it is appropriate to sort the names with a different department attribute only according to the first department contact frequency, or certainly, as described above, it is appropriate to sort the names with the same department attribute and the names with a different department attribute according to the first department contact frequency, the second department contact frequency, and the third department contact frequency, where the priority of the first department contact frequency is higher than a priority of the second department contact frequency.

In addition, the user may search for desired information according to the name in the name list, or the name list directly includes the information corresponding to each name, as shown in the name list 4, so as to save the user's search time.

Name list 4

| | Department | Phone number |
|---|---|---|
| Zhang Yi (3) | Planning | XXX |
| | department | |
| Zhang Yi (2) | Planning | XXX |
| | department | |
| Zhang Yi (5) | Sales department | XXX |
| Zhang Yi (4) | Sales department | XXX |
| Zhang Yi (1) | Marketing | XXX |
| | department | |

Step 205: Return the name list to the user, so that the user obtains contact information according to the name list.

In this embodiment, a finally generated name list, that is, the name list 4, is returned to the user.

According to a method for obtaining an address book in this embodiment, an apparatus for obtaining an address book sorts names to be searched for, for example, sorting them according to a department attribute or contact frequency, so that a user can find a desired name quickly and obtain corresponding contact information or other information, which saves the user's search time and improves user experience.

It can be imagined that, the names to be searched for may further include names that do not exactly match the name to be searched for, such as “Zhang Yiging”, “Zhang Yizhong”, “Lu Zhangyi” and “Zhang Hongyi”. The names that do not exactly match the name to be searched for may be placed below the names that exactly match the name to be searched for, and sorted in the foregoing manner.

Specifically, before the returning the name list to the user, the method further includes:

identifying priorities of the to-be-sorted names, where a priority of a to-be-sorted name that exactly matches the name to be searched for is higher than a priority of a to-be-sorted name that does not exactly match the name to be searched for; and

sorting the to-be-sorted names in descending order of the priorities.

This step may be inserted between any two steps of steps 200-204, which may be set according an actual requirement.

Assuming that the attribute of the to-be-sorted names obtained by the apparatus for obtaining an address book from the pre-stored database is shown in Table 2,

a final name list 5 generated according to the foregoing method is:

Name list 5

| | Department | Phone number |
|---|---|---|
| Zhang Yi (3) | Planning | XXX |
| | department | |
| Zhang Yi (2) | Planning | XXX |
| | department | |
| Zhang Yi (5) | Sales department | XXX |
| Zhang Yi (4) | Sales department | XXX |
| Zhang Yi (1) | Marketing | XXX |
| | department | |
| Zhang Hongyi | Planning | XXX |
| | department | |
| Zhang Yiqing | Sales department | XXX |
| Zhang Yizhong | Strategy | XXX |
| | department | |

Certainly, the name list 4 may also include only a name of a contact person. After the name list is returned to the user, the user obtains corresponding contact information according to the name of the contact person, which may be specifically set according to an actual requirement.

### Embodiment 3

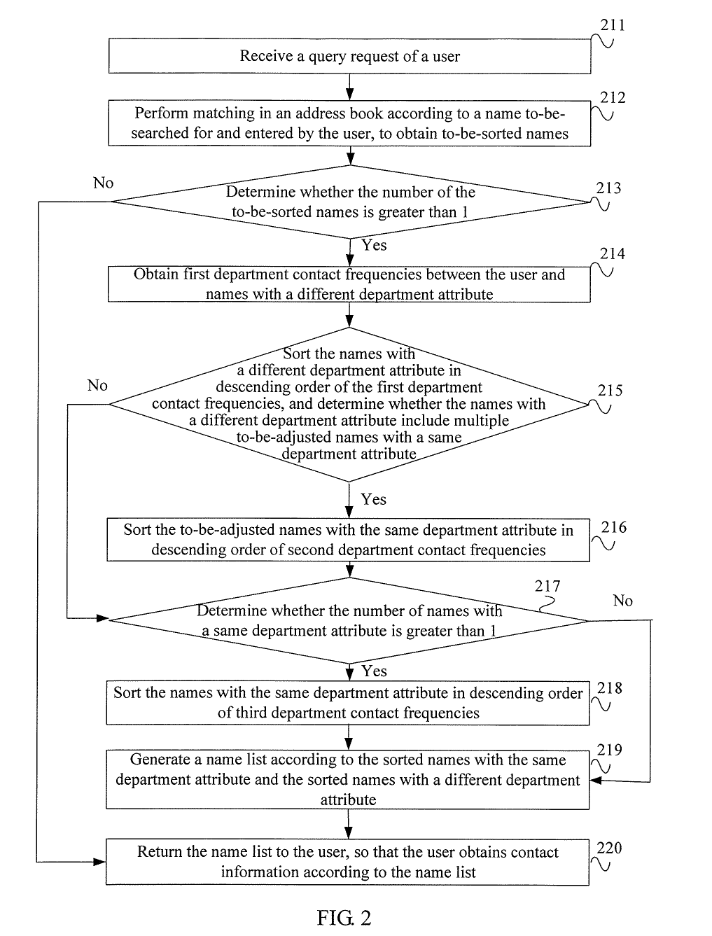

This embodiment provides a specific process of a method for obtaining an address book based on the foregoing embodiments, as shown in FIG. 2.

Step 211: Receive a query request of a user, where the query request includes a name to be searched for.

Step 212: Perform matching in the address book according to the name to be searched for and entered by the user, to obtain to-be-sorted names.

Step 213: Determine whether the number of the to-be-sorted names is greater than 1; when a result of the determining is yes, proceed to step 214; otherwise, go to step 220.

Step 214: Obtain first department contact frequencies between the user and names with a different department attribute, where the first department contact frequency is a sum of contact frequencies between the user and all users in a department to which the names with a different department attribute belong.

Step 215: Sort the names with a different department attribute in descending order of the first department contact frequencies, and determine whether the names with a different department attribute include multiple to-be-adjusted names with a same department attribute; and, if a result of the determining is yes, proceed to step 216; otherwise, go to step 217.

Step 216: Obtain second department contact frequencies between all to-be-adjusted names and the user, and sort the to-be-adjusted names in descending order of the second department contact frequencies, where the second department contact frequency is a sum of contact frequencies between the names with a different department attribute and all users in a department to which the user belongs.

Step 217: Determine whether the number of names with a same department attribute is greater than 1; when a result of the determining is yes, perform step 218; otherwise, perform step 219.

Step 218: Obtain third department contact frequencies between the names with the same department attribute and the user, and sort the names with the same department attribute in descending order of the third department contact frequencies, where the third department contact frequency is a sum of contact frequencies between the names with the same department attribute and all users in the department to which the user belongs.

Step 219: Generate a name list according to the sorted names with the same department attribute and the sorted names with a different department attribute, where the names with the same department attribute are arranged above the names with a different department attribute.

Step 220: Return the name list to the user, so that the user obtains contact information according to the name list.

Persons of ordinary skill in the art may understand that all or a part of the steps of the method embodiments may be implemented by a program instructing relevant hardware. The program may be stored in a computer readable storage medium. When the program runs, the steps of the method embodiments are performed. The foregoing storage medium includes any medium that can store program code, such as a ROM, a RAM, a magnetic disk, or an optical disc.

### Embodiment 4

This embodiment provides an apparatus for obtaining an address book, which is used to implement the method for obtaining an address book in the foregoing embodiments.

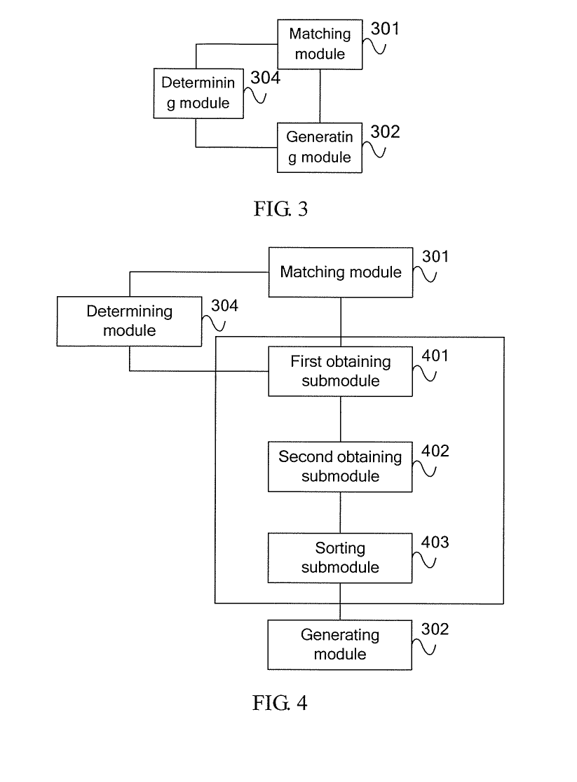

FIG. 3 is a schematic structural diagram of the apparatus for obtaining an address book according to this embodiment. The apparatus for obtaining an address book includes a matching module 301 and a generating module 302.

The matching module 301 is configured to perform matching in the address book according to a name to be searched for and entered by a user, to obtain to-be-sorted names; and the generating module 302 is connected to the matching module 301, and is configured to obtain a sorting attribute of the to-be-sorted names, sort the to-be-sorted names according to the sorting attribute, and generate a name list, where the sorting attribute includes a department attribute or a department contact frequency.

A specific operation manner of the apparatus for obtaining an address book in this embodiment is consistent with the operation manner in Embodiment 1, and is not repeated here.

Optionally, the apparatus for obtaining an address book in this embodiment further includes a determining module 304. The determining module 304 is separately connected to the matching module 301 and the generating module 302, and is configured to determine the number of the to-be-sorted names, and trigger the generating module 302 when the number of the to-be-sorted names is greater than 1.

According to an apparatus for obtaining an address book in this embodiment, names that match a name to be searched for are sorted according to a sorting attribute, so that a user can find a desired name quickly and obtain corresponding contact information or other information, which saves the user's search time and improves user experience.

### Embodiment 5

This embodiment provides an apparatus for obtaining an address book based on Embodiment 4.

As shown in FIG. 4, the apparatus for obtaining an address book in this embodiment includes the matching module 301 and the generating module 302 in the foregoing embodiment, where the generating module 302 specifically includes a first obtaining submodule 401, a second obtaining submodule 402 and a sorting submodule 403. The department contact frequency may include one or more of a first department contact frequency, a second department contact frequency, and a third department contact frequency.

The first obtaining submodule 401 is specifically connected to the matching module 301, and is connected to the determining module 304 when the determining module 304 exists, and the first obtaining submodule 401 is configured to obtain the department attribute of the to-be-sorted names; the second obtaining submodule 402 is connected to the first obtaining submodule 401 to obtain names with a department attribute that is the same as a department attribute of the user from the to-be-sorted names, and names with a department attribute that is different from the department attribute of the user from the to-be-sorted names; and the sorting submodule 403 is connected to the second obtaining submodule 402, and is configured to generate the name list according to the names with the same department attribute and the names with a different department attribute.

Optionally, the sorting submodule 403 is specifically configured to:

obtain first department contact frequencies between the user and the names with a different department attribute;

sort the names with a different department attribute in descending order of the first department contact frequencies; and

generate the name list according to the names with the same department attribute and the sorted names with a different department attribute, where the names with the same department attribute are arranged above the names with a different department attribute, and the first department contact frequency is a sum of contact frequencies between the user and all users in a department to which the names with a different department attribute belong.

Optionally, the sorting submodule 403 is further configured to:

when the names with a different department attribute include multiple to-be-adjusted names with a same department attribute, obtain second department contact frequencies between all to-be-adjusted names and the user; and

sort the to-be-adjusted names with the same department attribute in descending order of the second department contact frequencies, where

the second department contact frequency is a sum of contact frequencies between each to-be-adjusted name and all users in a department to which the user belongs.

Optionally, the sorting submodule 403 is further configured to:

obtain third contact frequencies between the names with the same department attribute and the user; and

sort the names with the same department attribute in descending order of the third department contact frequencies, where

the third contact frequency is a sum of contact frequencies between the names with the same department attribute and all users in a department to which the user belongs.

Optionally, in this embodiment, a priority identifying module (not shown in the figure) is further included. The priority identifying module is configured to identify priorities of the to-be-sorted names, where a priority of a to-be-sorted name that exactly matches the name to be searched for is higher than a priority of a to-be-sorted name that does not exactly match the name to be searched for; and sort the to-be-sorted names in descending order of the priorities. The priority identifying module may be located between the matching module 301 and the generating module 302, and, when the determining module 304 is included, may also be located between the determining module 304 and the generating module 302. Certainly, many other setting manners may be applied, which are not repeated here.

A specific operation manner of the apparatus for obtaining an address book in this embodiment is consistent with the operation manner in Embodiment 2, and is not repeated here.

According to an apparatus for obtaining an address book in this embodiment, the apparatus for obtaining an address book sorts names to be searched for, for example, sorting them according to a department attribute or contact frequency, so that a user can find a desired name quickly and obtain corresponding contact information or other information, which saves the user's search time and improves user experience.

### Embodiment 6

This embodiment provides a server, including a memory that is configured to store an instruction; and

a processor, coupled to the memory, and configured to execute the instruction stored in the memory and execute the method for obtaining an address book described in any one of the foregoing embodiments.

Specifically, the processor runs a program corresponding to executable program code by reading the executable program code stored in the memory, so as to:

perform matching in the address book according to a name to be searched for and entered by a user, to obtain to-be-sorted names; and

obtain a sorting attribute of the to-be-sorted names, sort the to-be-sorted names according to the sorting attribute, and generate a name list, where the sorting attribute includes a department attribute or a department contact frequency.

Optionally, after performing an operation of obtaining the to-be-sorted names and before obtaining the to-be-sorted names, the processor is further configured to:

determine the number of the to-be-sorted names; and

when the number of the to-be-sorted names is greater than 1, perform an operation of obtaining the sorting attribute of the to-be-sorted names.

Optionally, when the processor performs the step of obtaining a sorting attribute of the to-be-sorted names, sorting the to-be-sorted names according to the sorting attribute, and generating a name list, the processor is specifically configured to:

obtain the department attribute of the to-be-sorted names;

obtain names with a department attribute that is the same as a department attribute of the user from the to-be-sorted names, and names with a department attribute that is different from the department attribute of the user from the to-be-sorted names; and

generate the name list according to the names with the same department attribute and the names with a different department attribute.

Optionally, when the processor performs the operation of generating the name list according to the names with the same department attribute and the names with a different department attribute, the processor is specifically configured to:

obtain first department contact frequencies between the user and the names with a different department attribute;

sort the names with a different department attribute in descending order of the first department contact frequencies; and

generate the name list according to the names with the same department attribute and the sorted names with a different department attribute, where the names with the same department attribute are arranged above the names with a different department attribute, and

the first department contact frequency is a sum of contact frequencies between the user and all users in a department to which the names with a different department attribute belong.

Optionally, the processor runs a program corresponding to executable program code by reading the executable program code stored in the memory, and the processor may be further configured to:

after the sorting the names with a different department attribute in descending order of the first department contact frequencies and before the generating the name list according to the names with the same department attribute and the sorted names with a different department attribute,

when the names with a different department attribute include multiple to-be-adjusted names with a same department attribute, obtain second department contact frequencies between all to-be-adjusted names and the user; and

sort the to-be-adjusted names with the same department attribute in descending order of the second department contact frequencies, where

the second department contact frequency is a sum of contact frequencies between each to-be-adjusted name and all users in a department to which the user belongs.

Optionally, the processor runs a program corresponding to executable program code by reading the executable program code stored in the memory, and the processor may be further configured to:

before the generating the name list according to the names with the same department attribute and the sorted names with a different department attribute,

obtain third contact frequencies between the names with the same department attribute and the user; and

sort the names with the same department attribute in descending order of the third department contact frequencies, where

the third contact frequency is a sum of contact frequencies between the names with the same department attribute and all users in a department to which the user belongs.

Optionally, before the processor runs a program corresponding to executable program code by reading the executable program code stored in the memory, so as to return the name list to the user, the following is further included:

identifying priorities of the to-be-sorted names, where a priority of a to-be-sorted name that exactly matches the name to be searched for is higher than a priority of a to-be-sorted name that does not exactly match the name to be searched for; and

sorting the to-be-sorted names in descending order of the priorities.

According to a server in this embodiment, names that match a name to be searched for are sorted according to a sorting attribute, so that a user can find a desired name quickly and obtain corresponding contact information or other information, which saves the user's search time and improves user experience.

Finally, it should be noted that the foregoing embodiments are merely intended for describing the technical solutions of the present invention other than limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of the embodiments of the present invention.

What is claimed is:

1. A method for obtaining an address book, the method comprising:
performing matching in the address book according to a name to be searched for and entered by a user, to obtain to-be-sorted names; and
obtaining a sorting attribute of the to-be-sorted names, sorting the to-be-sorted names according to the sorting attribute, and generating a name list, wherein the sorting attribute comprises a department attribute or a department contact frequency.

2. The method for obtaining an address book according to claim 1, wherein obtaining a sorting attribute of the to-be-sorted names, sorting the to-be-sorted names according to the sorting attribute, and generating a name list, comprise:
obtaining the department attribute of the to-be-sorted names;
obtaining names with a department attribute that is the same as a department attribute of the user from the to-be-sorted names, and names with a department attribute that is different from the department attribute of the user from the to-be-sorted names; and
generating the name list according to the names with the same department attribute and the names with a different department attribute.

3. The method for obtaining an address book according to claim 2, wherein generating the name list according to the names with the same department attribute and the names with a different department attribute comprises:
obtaining first type of department contact frequencies between the user and the names with a different department attribute;
sorting the names with a different department attribute in descending order of the first type of department contact frequencies; and
generating the name list according to the names with the same department attribute and the sorted names with a different department attribute, wherein the names with the same department attribute are arranged above the names with a different department attribute.

4. The method for obtaining an address book according to claim 3, wherein the first type of department contact frequencies are a sum of contact frequencies between the user and all users in a department to which the names with a different department attribute belong.

5. The method for obtaining an address book according to claim 3, wherein, after sorting the names with a different department attribute in descending order of the first type of department contact frequencies and before generating the name list according to the names with the same department attribute and the sorted names with a different department attribute, the method further comprises:
when the names with a different department attribute comprise multiple to-be-adjusted names with a same department attribute, obtaining second type of department contact frequencies between all to-be-adjusted names and the user; and
sorting the to-be-adjusted names with the same department attribute in descending order of the second type of department contact frequencies.

6. The method for obtaining an address book according to claim 5, wherein the second type of department contact frequencies are a sum of contact frequencies between each to-be-adjusted name and all users in a department to which the user belongs.

7. The method for obtaining an address book according to claim 2, wherein, before generating the name list according to the names with the same department attribute and the sorted names with a different department attribute, the method further comprises:
obtaining third type of department contact frequencies between the names with the same department attribute and the user; and
sorting the names with the same department attribute in descending order of the third type of department contact frequencies, wherein the third type of department contact frequencies are a sum of contact frequencies between the names with the same department attribute and all users in the department to which the user belongs.

8. The method for obtaining an address book according to claim 1, wherein, after obtaining to-be-sorted names, and before obtaining a sorting attribute of the to-be-sorted names, the method further comprises:
determining the number of the to-be-sorted names; and
when the number of the to-be-sorted names is greater than 1, performing an operation of obtaining the sorting attribute of the to-be-sorted names.

9. The method for obtaining an address book according to claim 1, wherein, before returning the name list to the user, the method further comprises:
identifying priorities of the to-be-sorted names, wherein a priority of a to-be-sorted name that exactly matches the name to be searched for is higher than a priority of a to-be-sorted name that does not exactly match the name to be searched for; and
sorting the to-be-sorted names in descending order of the priorities.

10. An apparatus for obtaining an address book, the apparatus comprising:
a matching module, configured to perform matching in the address book according to a name to be searched for and entered by a user, to obtain to-be-sorted names; and
a generating module, configured to obtain a sorting attribute of the to-be-sorted names, sort the to-be-sorted names according to the sorting attribute, and generate a name list, wherein the sorting attribute comprises a department attribute or a department contact frequency.

11. The apparatus for obtaining an address book according to claim 10, wherein the generating module comprises:
a first obtaining submodule, configured to obtain the department attribute of the to-be-sorted names;
a second obtaining submodule, configured to obtain names with a department attribute that is the same as a department attribute of the user from the to-be-sorted names, and names with a department attribute that is different from the department attribute of the user from the to-be-sorted names; and
a sorting submodule, configured to generate the name list according to the names with the same department attribute and the names with a different department attribute.

12. The apparatus for obtaining an address book according to claim 11, wherein the sorting submodule is configured to:
obtain first type of department contact frequencies between the user and the names with a different department attribute;
sort the names with a different department attribute in descending order of the first type of department contact frequencies; and
generate the name list according to the names with the same department attribute and the sorted names with a different department attribute, wherein the names with the same department attribute are arranged above the names with a different department attribute.

13. The apparatus for obtaining an address book according to claim 11, wherein the sorting submodule is further configured to:
when the names with a different department attribute comprise multiple to-be-adjusted names with a same department attribute, obtain second type of department contact frequencies between all to-be-adjusted names and the user; and
sort the to-be-adjusted names with the same department attribute in descending order of the second type of department contact frequencies.

14. The apparatus for obtaining an address book according to claim 10, wherein the sorting submodule is further configured to:
obtain third type of department contact frequencies between the names with the same department attribute and the user; and
sort the names with the same department attribute in descending order of the third type of department contact frequencies, wherein the third type of department contact frequencies are a sum of contact frequencies between the names with the same department attribute and all users in a department to which the user belongs.

15. The apparatus for obtaining an address book according to claim 10, further comprising:
a determining module, configured to:
determine the number of the to-be-sorted names; and
when the number of the to-be-sorted names is greater than 1, perform an operation of obtaining the sorting attribute of the to-be-sorted names.

16. The apparatus for obtaining an address book according to claim 10, further comprising:
a priority identifying module, configured to identify priorities of the to-be-sorted names, wherein a priority of a to-be-sorted name that exactly matches the name to be searched for is higher than a priority of a to-be-sorted name that does not exactly match the name to be searched for; and sort the to-be-sorted names in descending order of the priorities.

17. A server, comprising:
a memory, configured to store an instruction; and
a processor, coupled to the memory, and configured to execute the instruction stored in the memory and execute the method for obtaining an address book according to claim 1.
